(19) United States
(12) Patent Application Publication
(10) Pub. No.: US 2010/0025025 A1
(43) Pub. Date: Feb. 4, 2010

(54) HEAT EXCHANGER AND MANUFACTURING METHOD OF THE SAME

(76) Inventors: Kazuyoshi Tomochika, Gunma (JP); Norio Sawada, Gunma (JP); Hiroshi Mukaiyama, Gunma (JP); Kotaro Matsu, Tokyo (JP)

Correspondence Address: MCDERMOTT WILL & EMERY LLP, 600 13TH STREET, N.W., WASHINGTON, DC, 20005-3096, US

(21) Appl. No.: 12/442,282

(22) PCT Filed: Sep. 26, 2007
(86) PCT No.: PCT/JP2007/068682

§ 371 Date: Mar. 20, 2009

(30) Foreign Application Priority Data
Sep. 28, 2006 (JP) 2006-264940

(51) Int. Cl. F28F 3/00; B23P 15/26

(52) U.S. Cl. 165/166; 29/890.046

(57) ABSTRACT

There is disclosed a heat exchanger capable of suppressing the increase of a pressure drop while improving a non-uniform rate distribution of a fluid. A heat exchanger T of the present invention is constituted of flat plates 1, 2 each having an inflow port 15 of the fluid on one end thereof and an outflow port 16 of the fluid on the other end, and offset type fins 5 provided in the flat plates 1, 2, and includes a fin orthogonal region H where the plate fins 5 cross the flow direction of the fluid from the inflow port 15 to the outflow port 16 at right angles and a fin parallel region V where the plate fins 5 are disposed in parallel with the flow direction of the fluid from the inflow port 15 to the outflow port 16, the fin orthogonal regions H are provided on the sides of the inflow port 15 and the outflow port 16, and the fin parallel region V is provided between the respective fin orthogonal regions H.

### BACKGROUND OF THE INVENTION

The present invention relates to a heat exchanger for performing heat exchange between a first fluid and a second fluid, and a manufacturing method of the heat exchanger.

This type of heat exchanger, for example, a heat exchanger including offset type fins is constituted of a plurality of flat plates, and the offset type fins provided between an inflow port formed in one end of each flat plate in a longitudinal direction and an outflow port formed in the other end thereof. The flat plates are provided with flow paths of the fluid which flows into the inflow port of the one end, flows toward the other end through spaces among the fins, and is discharged from the outflow port.

Each of the fins is formed by forming a pair of cutouts at predetermined intervals from shoulders of both side walls of each protrusion having a trapezoidal section to bottom plate portions, and bending the corresponding portions inwardly, and has such an offset shape. Moreover, usually a plurality of flat plates are laminated, and a first fluid and a second fluid are alternately allowed to flow into the flow paths formed in the respective flat plates, so that heat exchange between both the fluids can be performed (e.g., see Japanese Patent Application Laid-Open No. 2003-314985).

In addition, the above fins are arranged in the flat plates so that the fins have one of orthogonal and parallel directions with respect to the flow of each fluid flowing through the flow paths. However, when the fins are arranged so as to cross the flow of the fluid at right angles, an area where the fluid collides with the fins enlarges, and hence the fluid is easily dispersed in the whole flow paths by the fins, and can be allowed to uniformly flow through the whole flow paths, but a problem that a pressure drop remarkably increases has occurred.

On the other hand, when the fins are arranged in parallel with the flow of the fluid, the area where the fluid collides with the fins decreases, and hence the pressure drop decreases, but the fluid is not easily dispersed in the whole flow paths. Therefore, the fluid cannot uniformly be allowed to flow through the whole flow paths, and the performance of the heat exchanger remarkably lowers.

### SUMMARY OF THE INVENTION

To solve such conventional problems, the present invention has been developed, and an object thereof is to provide a heat exchanger capable of suppressing the increase of a pressure drop while improving the non-uniform rate distribution of the fluid.

A heat exchanger of the present invention is characterized by having a flow path of a first fluid and a flow path of a second fluid and performing heat exchange between both the fluids, the flow paths including flat plates each having an inflow port of the fluid on one end thereof and an outflow port of the fluid on the other end thereof and fins provided in the flat plates, the heat exchanger comprising: a fin orthogonal region where the fins cross the flow direction of the fluid from the inflow port to the outflow port; and a fin parallel region where the fins are disposed in parallel with the flow direction of the fluid from the inflow port to the outflow port.

A heat exchanger of the invention of a second aspect is characterized in that in the invention according the first aspect, the fin orthogonal regions are provided on the sides of the inflow port and the outflow port, and the fin parallel region is provided between the respective fin orthogonal regions.

A heat exchanger of the invention of a third aspect is characterized in that in the invention of the first aspect or the second aspect, the fins are offset type fins having a rectangular wavy shape.

A heat exchanger of the invention of a fourth aspect is characterized in that in the invention of any one of the first to third aspects, the first fluid or the second fluid is carbon dioxide.

A heat exchanger manufacturing method of a fifth aspect is a manufacturing method of the heat exchanger according to any one of the first to fourth aspects, characterized by integrating, with respect to the flow direction of the fluid, a difference between the maximum flow velocity and the minimum flow velocity of the fluid in a plane crossing the flow direction of the fluid at right angles; increasing the ratio of the fin orthogonal region with respect to the whole; obtaining, as the maximum value, an inflection point where the tilt of the integrated value becomes moderate; and setting the ratio of the fin orthogonal region within a range of a value larger than zero to a value of the maximum or less.

The manufacturing method of the heat exchanger of the sixth aspect is characterized in that the invention according to any one of the first to fifth aspects further comprising the steps of: separately forming the flat plates and the fins; and receiving the formed fins in the flat plates.

According to the present invention, the heat exchanger has the flow path of the first fluid and the flow path of the second fluid and performs the heat exchange between both the fluids, and the flow paths include the flat plates each having the inflow port of the fluid on one end thereof and the outflow port of the fluid on the other end thereof and the fins provided in the flat plates. The heat exchanger comprises the fin orthogonal region where the fins cross the flow direction of the fluid from the inflow port to the outflow port; and the fin parallel region where the fins are disposed in parallel with the flow direction of the fluid from the inflow port to the outflow port. Therefore, the fluid can be dispersed in the whole flow paths by the fin orthogonal region, and the fluid can be allowed to flow smoothly in the fin parallel region.

In consequence, while improving the non-uniform rate distribution by the fin orthogonal region, a disadvantage that the pressure drop increases in the fin parallel region can be eliminated.

Particularly, as in the second aspect, the fin orthogonal regions are provided on the sides of the inflow port and the outflow port, and the fin parallel region is provided between the respective fin orthogonal regions. In consequence, drift around the inflow port and the outflow port can effectively be eliminated, and the whole flow paths can effectively be utilized, so that the improvement of a heat exchange performance can be realized.

Furthermore, as in the third aspect, the fins are the offset type fins having the rectangular wavy shape. In consequence, the fins come in face contact with the flat plates, and hence the pressure resistance of the heat exchanger can be improved. Therefore, as in the fourth aspect, as at least one of the first fluid and the second fluid, a high-pressure fluid such as carbon dioxide may be used.

According to the manufacturing method of the heat exchanger of the fifth aspect, in the heat exchanger according to any one of the first to fourth aspects, when the difference between the maximum flow velocity and the minimum flow velocity of the fluid in the plane crossing the flow direction of the fluid at right angles is integrated with respect to the flow direction of the fluid and the ratio of the fin orthogonal region with respect to the whole is increased, the inflection point where the tilt of the integrated value becomes moderate is obtained as the maximum value, and the ratio of the fin orthogonal region is set within a range of a value larger than zero to a value of the maximum value or less. In consequence, it is possible to manufacture a high-performance heat exchanger capable of improving the non-uniform rate distribution and having less pressure drop.

Moreover, as in the sixth aspect, when the flat plates and the fins are separately formed and the formed fins are received in the flat plates to manufacture the heat exchanger, it is possible to manufacture the heat exchanger capable of arbitrarily setting the ratio between the fin orthogonal region and the fin parallel region in accordance with an application, use conditions or the like without any noticeable change of a mold.

### BRIEF DESCRIPTION OF THE DRAWINGS

FIG. 1 is a perspective view schematically showing a constitution of a heat exchanger of one embodiment of the present invention;

FIG. 2 is a main part perspective view of a fin constituting a part of each unit of the heat exchanger of FIG. 1;

FIG. 3 is a main part perspective view of a fin constituting a part of each unit of the heat exchanger of FIG. 1;

FIG. 4 is an explanatory view showing the flow of first and second fluids flowing through the heat exchanger of FIG. 1;

FIG. 5 is an explanatory view in a case where the fins of FIG. 2 are arranged in parallel with the flow of the fluid;

FIG. 6 is an explanatory view in a case where the fins of FIG. 2 are arranged so as to cross the flow of the fluid at right angles;

FIG. 7 is a diagram showing the rate distribution of the fluid flowing through a V-type unit;

FIG. 8 is a diagram showing the rate distribution in the flow direction of FIG. 7;

FIG. 9 is a diagram showing the rate distribution of the fluid flowing through an H-type unit;

FIG. 10 is a diagram showing the rate distribution in the flow direction of FIG. 9;

FIG. 11 is a front view schematically showing a unit of one example constituting the heat exchanger of the present invention;

FIG. 12 is a diagram showing the rate distribution of the fluid flowing through the V-type unit of FIG. 7 and the rate distribution of the fluid flowing through a first unit;

FIG. 13 is a diagram showing the rate distribution in the flow direction of the fluid flowing through the first unit of FIG. 12;

FIG. 14 is a diagram showing the rate distribution of the fluid flowing through the V-type unit of FIG. 7 and the rate distribution of the fluid flowing through a second unit;

FIG. 15 is a diagram showing the rate distribution in the flow direction of the fluid flowing through the second unit of FIG. 14;

FIG. 16 is a diagram showing the rate distribution of the fluid flowing through the V-type unit of FIG. 7 and the rate distribution of the fluid flowing through a third unit;

FIG. 17 is a diagram showing the rate distribution of the fluid flowing through the V-type unit of FIG. 7 and the rate distribution of the fluid flowing through a fourth unit;

FIG. 18 is a diagram showing the rate distribution of the fluid flowing through the first unit of FIG. 12 and the rate distribution of the fluid flowing through a fifth unit;

FIG. 19 is a diagram showing the rate distribution in the flow direction of the fluid flowing through the fifth unit;

FIG. 20 is a diagram showing the rate distribution of the fluid flowing through the second unit of FIG. 14 and the rate distribution of the fluid flowing through a sixth unit;

FIG. 21 is a diagram showing the rate distribution in the flow direction of the fluid flowing through the sixth unit of FIG. 20;

FIG. 22 is a diagram showing the rate distribution of the fluid flowing through the first unit of FIG. 12 and the rate distribution of the fluid flowing through a seventh unit;

FIG. 23 is a diagram showing the rate distribution in the flow direction of the fluid flowing through the seventh unit of FIG. 22;

FIG. 24 is a diagram showing the rate distribution of the fluid flowing through the second unit of FIG. 14 and the rate distribution of the fluid flowing through an eighth unit;

FIG. 25 is a diagram showing the rate distribution in the flow direction of the fluid flowing through the eighth unit of FIG. 24; and

FIG. 26 is a diagram showing changes of a pressure drop and a flow velocity deviation accompanying a change of a ratio of a fin orthogonal region H with respect to all the fins.

### DESCRIPTION OF THE PREFERRED EMBODIMENT

The present invention relates to a heat exchanger for performing heat exchange between fluids, and has been developed to eliminate a disadvantage that a pressure drop increases in a case where fins are arranged so as to cross fluid flow at right angles and to improve the drift of the fluid in a case where the fins are arranged in parallel with the fluid flow. A purpose of suppressing the pressure drop while improving the non-uniform rate distribution of the fluid is realized by disposing a fin orthogonal region where the fins cross the flow direction of the fluid from an inflow port to an outflow port at right angles and a fin parallel region where the fins are arranged in parallel with the flow direction of the fluid from the inflow port to the outflow port. Hereinafter, embodiments of the present invention will be described in detail with reference to the drawings.

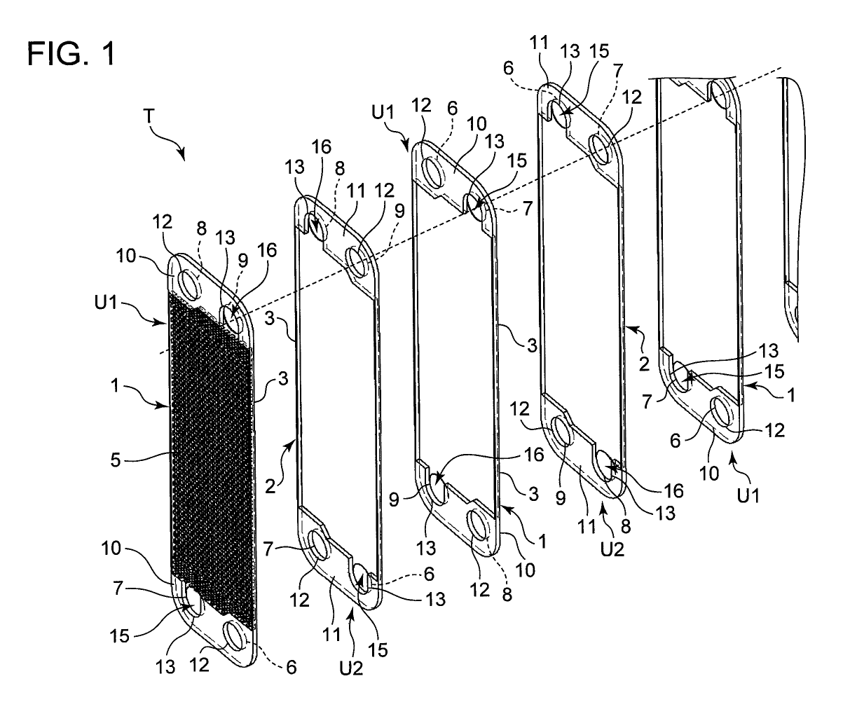

FIG. 1 is a perspective view schematically showing a constitution of a heat exchanger of one embodiment of the present invention. A heat exchanger T is used as a radiator, an evaporator or the like of a refrigerant cycle device, and performs heat exchange between, for example, a refrigerant (a first fluid) and water (a second fluid). In the heat exchanger T, units U1 and U2 are alternately laminated and joined, a cover plate (not shown) is attached to the unit U1 on one end, and couplings are attached to the units U1, U2 on both ends.

The units U1, U2 are constituted of flat plates 1 and 2 each having a peripheral wall portion 3 raised from the peripheral edge of a bottom surface in a vertical direction, a plurality of fins 5 received in both the flat plates 1, 2 and the like. The flat plates 1, 2 and the fins 5 of the present embodiment are made of stainless steel, and are formed by processing a plate material of stainless steel.

Each of the above flat plates 1, 2 is provided with two holes 6, 7 formed in one end of a longitudinal direction and extending through the end in the vertical direction, and is similarly provided with holes 8, 9 formed in the other end. The holes 6, 7 formed in the one end and the holes 8, 9 formed in the other end are formed in symmetric positions with respect to the center of the flat plate 1 or 2 in the longitudinal direction. Moreover, the flat plate 1 is provided with guide plates 10 arranged on both ends thereof. Each of these guide plates 10 is provided with a round hole 12 and a U-shaped cutout hole 13. The round hole 12 of the guide plate 10 is formed in a position substantially corresponding to the hole 6 or 8 of the flat plate 1, and the cutout hole 13 is formed in a position substantially corresponding to the hole 7 or 9 of the flat plate 1.

Similarly, the flat plate 2 is provided with guide plates 11 arranged on both ends thereof. Each of these guide plates 11 is also provided with a round hole 12 and a U-shaped cutout hole 13. The round hole 12 of the guide plate 11 is formed in a position substantially corresponding to the hole 7 or 9 of the flat plate 2, and the cutout hole 13 is formed in a position substantially corresponding to the hole 6 or 8 of the flat plate 2. That is, the round holes 12 and the cutout holes 13 of the guide plates 10 and 11 are formed on sides opposite to each other.

Both the guide plates 10, 11 are guide members for leading fluids into the respective containers 1, 2, and have a thickness substantially equal to that of the fins 5 described later.

Moreover, the round hole 12 of the guide plate 10 communicates with the hole 6 or 8 formed in the flat plate 1, and the hole 6 and the round hole 12 connected to each other and the hole 8 and the round hole 12 connected to each other form a fluid passage connecting passages to each other to connect both the units U1, U2 to each other in a state in which the units U1, U2 are laminated as described later.

Similarly, the round hole 12 of the guide plate 11 communicates with the hole 7 or 9 formed in the flat plate 2, and the hole 7 and the round hole 12 connected to each other and the hole 9 and the round hole 12 connected to each other form a fluid passage (not shown) connecting passages to each other to connect both the units U1, U2 to each other in a state in which the units U1, U2 are laminated as described later.

Moreover, the cutout hole 13 of the guide plate 10 communicates with the hole 7 or 9 formed in the flat plate 1, and in the laminated state of both the units U1, U2, the hole 7 and the cutout hole 13 connected to each other form an inflow port 15 to a flow path 4 of the fluid, and the hole 9 and the cutout hole 13 connected to each other form an outflow port 16 to the flow path 4 of the fluid.

Similarly, the cutout hole 13 of the guide plate 11 communicates with the hole 6 or 8 formed in the flat plate 2, and in the laminated state of both the units U1, U2, the hole 6 and the cutout hole 13 connected to each other form an inflow port 15 to a flow path 4 of the fluid, and the hole 8 and the cutout hole 13 connected to each other form an outflow port 16 to the flow path 4 of the fluid.

On the other hand, the fins 5 have a constitution in which the sides of one set of facing fins have a height dimension substantially equal to that of the peripheral wall portion 3 of the flat plate 1 or 2 and in which the sides of the other set of facing fins have a width (an inner width) substantially equal to that of the flat plate 1 or 2. The fins are successively received between the guide plates 10 and 11 arranged in the flat plates 1, 2 on both the ends so that in a state in which the fins are received in the flat plate 1, one of the sides of the set of fins 5 abuts on the bottom of the flat plate 1 or 2, the other side is positioned in the upper surface of the container, and the side of the other set abuts on the peripheral wall portion 3. That is, in one flat plate 1 or 2, a plurality of fins 5 are successively received between the guide plate 10 or 11 on one end and the guide plate 10 or 11 on the other end, and the side of each fin that abuts on the peripheral wall portion 3 is bonded to the peripheral wall portion 3 with a brazing material.

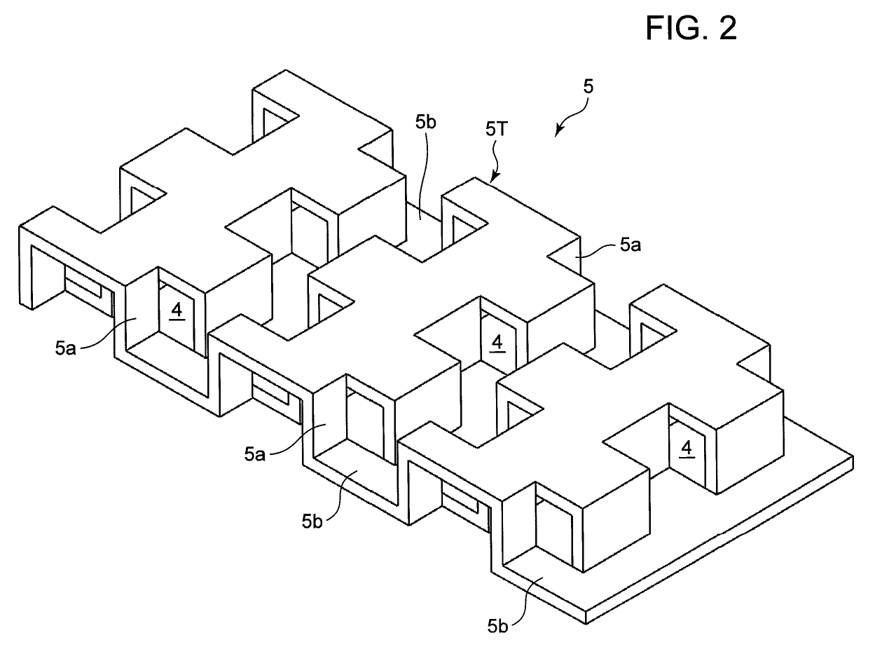

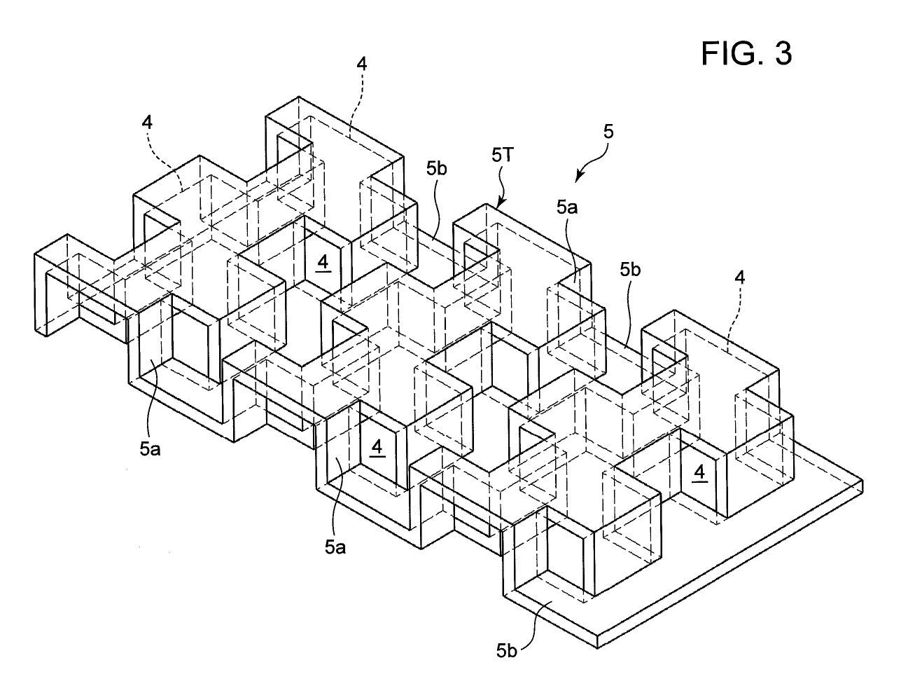

In each fin 5, as shown in FIGS. 2 and 3, both side walls 5a of each protrusion 5T having a trapezoidal section are provided with a pair of cutouts formed at predetermined intervals from shoulders of the side walls to each bottom plate portion 5b, cutout portions are bent inwardly, and this protrusion 5T has an offset shape. That is, the fin 5 is an offset type fin having a substantially rectangular wavy shape. Since the fin 5 having the rectangular wavy shape is formed in this manner, the respective fins 5 . . . come in face contact with the flat plates 1, 2 in a case where the units U1 and U2 are alternately laminated and joined as described above. Thus, the fins 5 are formed in the rectangular wavy shape so as to come in face contact with the flat plates 1, 2, so that the pressure resistance of the heat exchanger T can be improved. By such improvement of the pressure resistance, a high-pressure fluid such as carbon dioxide can be allowed to flow through the heat exchanger T. It is to be noted that in FIG. 3, reference numeral 4 is the flow path of the fluid.

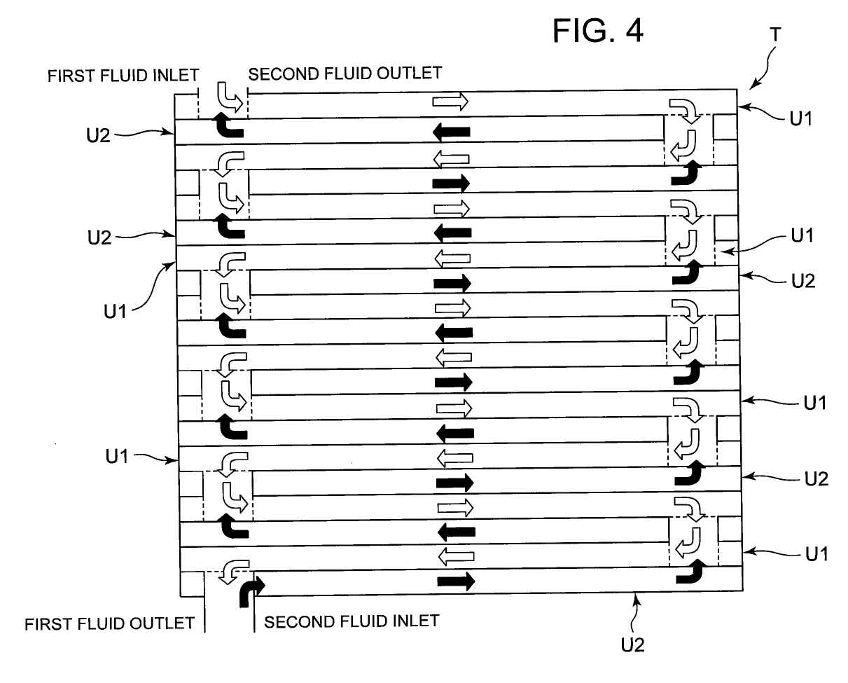

Moreover, the above-mentioned units U1 and U2 are alternately laminated in a frame member (not shown), and the abutment faces of the adjacent units U1 and U2 are bonded to each other with the brazing material to constitute the heat exchanger T. Furthermore, as shown in FIG. 1, the respective units U1 sandwich each unit U2 therebetween and are laminated so that the inflow port 15 and the outflow port 16 are positioned on the opposite sides. Similarly, the respective units U2 sandwich each unit U1 therebetween and are laminated so that the inflow port 15 and the outflow port 16 are positioned on the opposite sides. In consequence, as shown in FIG. 4, in the heat exchanger T, the first fluid flows through each unit U1 in a winding manner, and the second fluid flows through each unit U2 in the winding manner (e.g., white arrows of FIG. 4 show the flow of the first fluid, and black arrows of FIG. 4 show the flow of the second fluid). Moreover, since the units U1 and U2 are alternately laminated, as shown in FIG. 4, the first and second fluids alternately flow as counter flows through the adjacent units U1, U2, and heat exchange between both the fluids can effectively be performed.

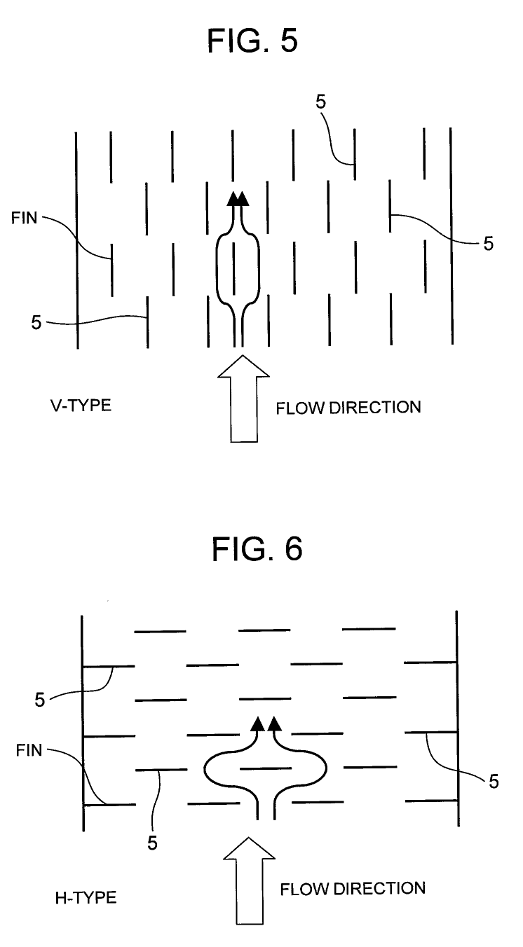

In addition, heretofore, the plurality of fins 5 received in the flat plates 1, 2 of the respective units U1, U2 have a constitution in which the fins are arranged in parallel with the flow direction of the fluid from the inflow port 15 to the outflow port 16 as shown in FIG. 5 (hereinafter referred to as the V-type unit) or a constitution in which the fins 5 are arranged so as to cross the flow direction of the fluid from the inflow port 15 to the outflow port 16 at right angles as shown in FIG. 6 (hereinafter referred to as the H-type unit), and the fins are laminated as described above to constitute the heat exchanger.

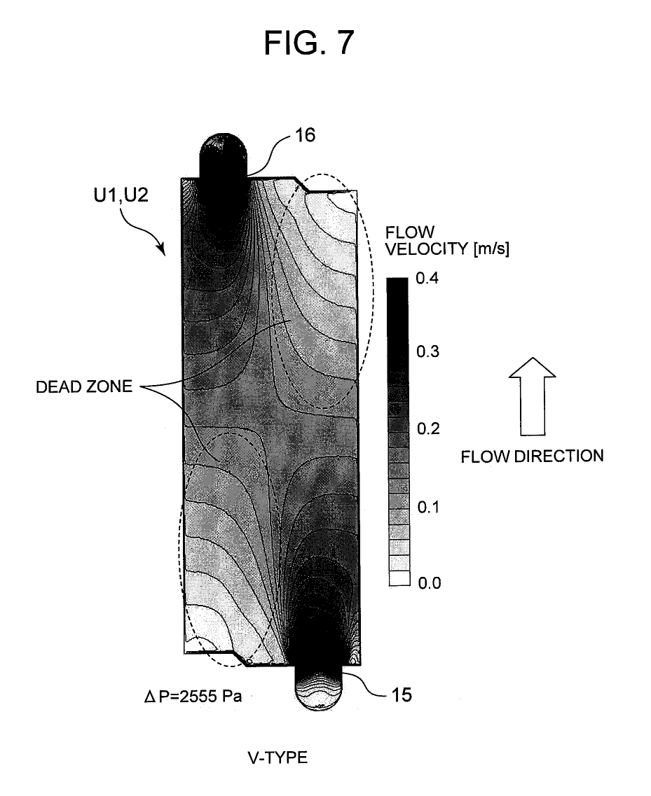

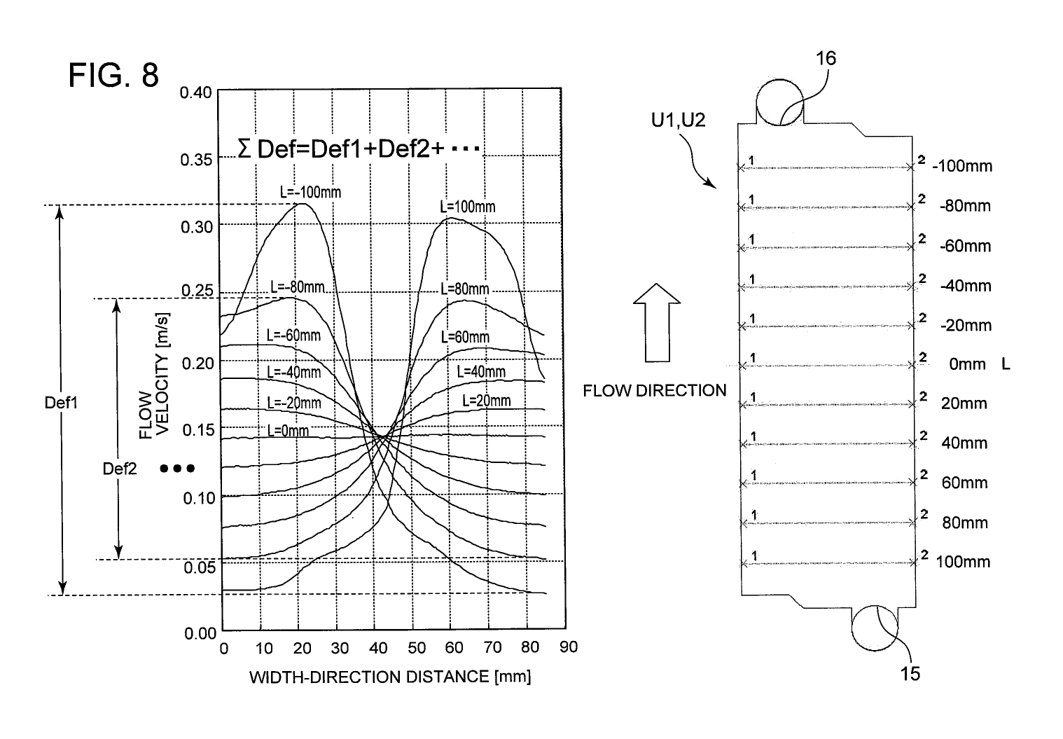

Here, FIGS. 7 and 8 show the rate distributions of the respective fluids flowing through the respective units U1, U2 in a case where the units U1, U2 are constituted of the V-type units. It is to be noted that the flow velocity of the fluid flowing through the heat exchanger is set to 2 L/min. In FIG. 8, the ordinate indicates the flow velocity of the fluid, and the abscissa indicates the width-direction distance of each unit U1 or U2 (i.e., a length dimension from one end 1 to the other end 2 of each unit U1 or U2 shown in FIG. 8). Moreover, Def of each unit U1 or U2 is a difference between the maximum flow velocity Umax and the minimum flow velocity Umin of the fluid along the face of the unit U1 or U2 crossing the fluid flow direction at right angles. When this difference is integrated in the fluid flow direction, the flow velocity deviation of the fluid can be calculated. That is, as the flow velocity deviation is large, the flow of the fluid through the flow path 4 becomes non-uniform, and drift is generated. It is apparent from both FIGS. 7, 8 that the flow velocity of the fluid flowing through the flow path 4 is highest around the inflow port 15 and the outflow port 16, the flow of the fluid is concentrated on the flow path 4 substantially linearly connecting the inflow port 15 to the outflow port 16, and the flow velocity of the fluid drops around the flow path. In particular, a position opposite to the inflow port 15 of the unit U1 or U2 and a position opposite to the outflow port 16, that is, around the left side of a lower end and the right side of an upper end in FIG. 7, a dead zone where the fluid hardly flows is generated.

Thus, it has been found that in the V-type unit, the flow velocity of the fluid through each flow path 4 does not become uniform, the drift is generated, and the rate deviation of the fluid increases. It is to be noted that in the heat exchanger constituted of the V-type unit, a pressure difference of the fluid between an inlet side and an outlet side in the heat exchanger is 2555 Pa.

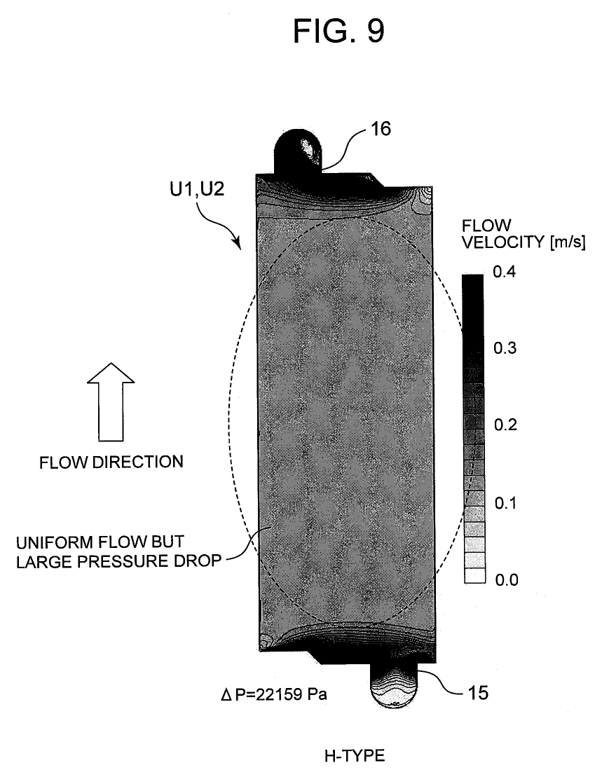

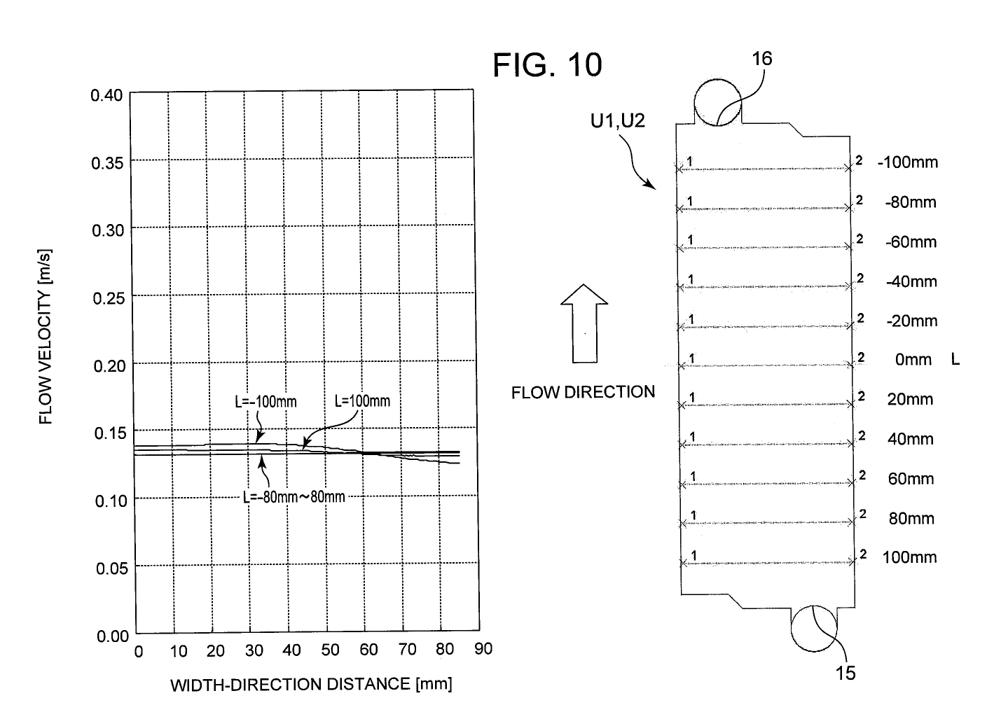

On the other hand, FIGS. 9 and 10 show the rate distribution of the fluid flowing through the unit U1 or U2 in a case where the units U1, U2 are constituted of the H-type units. The flow velocity of the fluid flowing through the heat exchanger is similarly set to 2 L/min. It is apparent from both FIGS. 9, 10 that the fluid substantially uniformly flows through the whole flow paths 4. Thus, it has been found that in the H-type unit, the fluid is dispersed in the whole flow paths 4, and substantially uniformly flows therethrough. However, in the H-type unit, since the fins 5 are arranged so as to cross the flow direction of the fluid at right angles, the pressure difference of the fluid between the inlet side and the outlet side in the heat exchanger constituted of the H-type unit is 22159 Pa, and pressure drop remarkably increases.

To solve the above problems of the fluid drift and the pressure drop, the heat exchanger T of the present invention has a constitution including a fin orthogonal region H where the fins 5 cross the flow direction of the fluid from the inflow port 15 to the outflow port 16 at right angles and a fin parallel region V where the fins 5 are parallel to the flow direction of the fluid from the inflow port 15 to the outflow port 16.

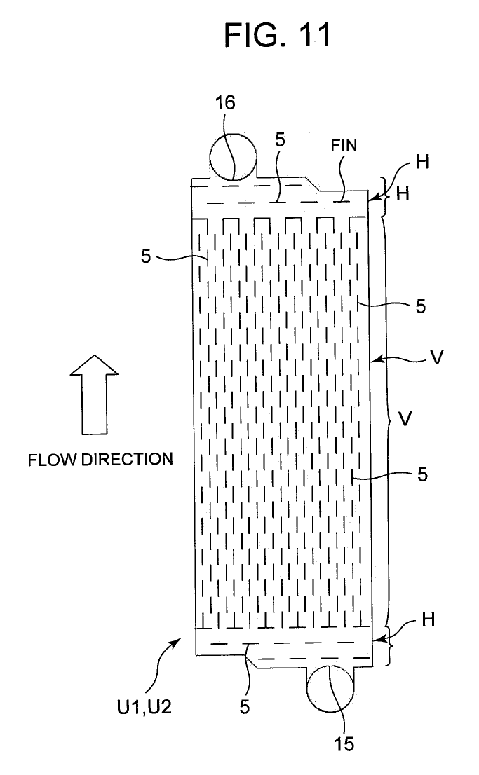

Here, an arrangement method of the above fin orthogonal region H and the fin parallel region V will specifically be investigated. First, there will be investigated a case where as shown in FIG. 11, the fin orthogonal regions H are arranged on the sides of the inflow port 15 and the outflow port 16, and each fin parallel region V is arranged between the fin orthogonal regions H.

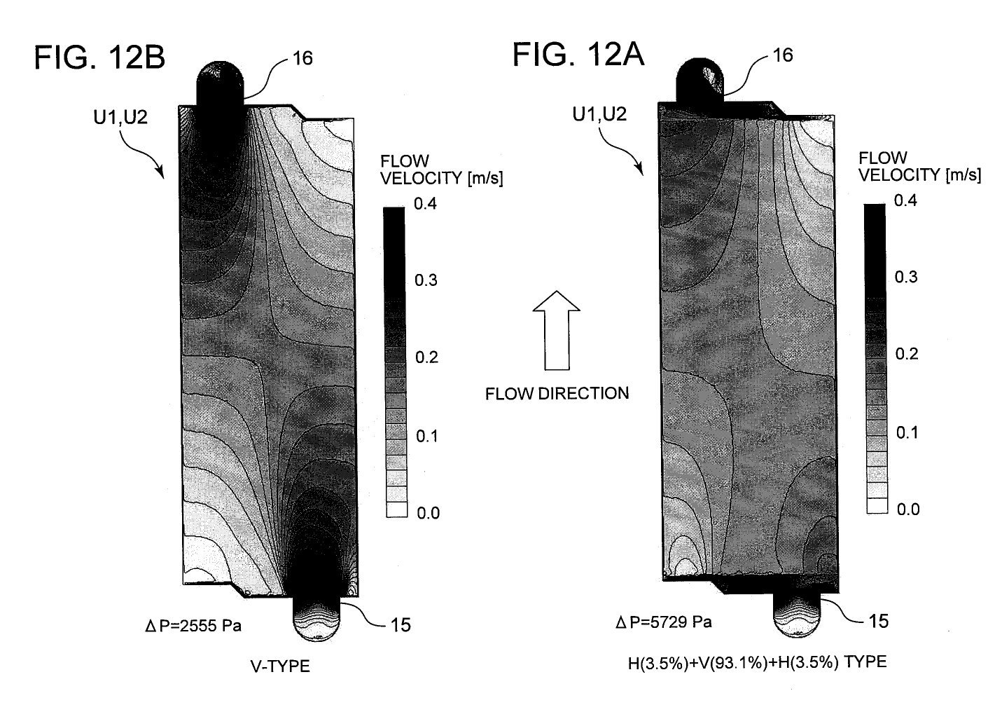

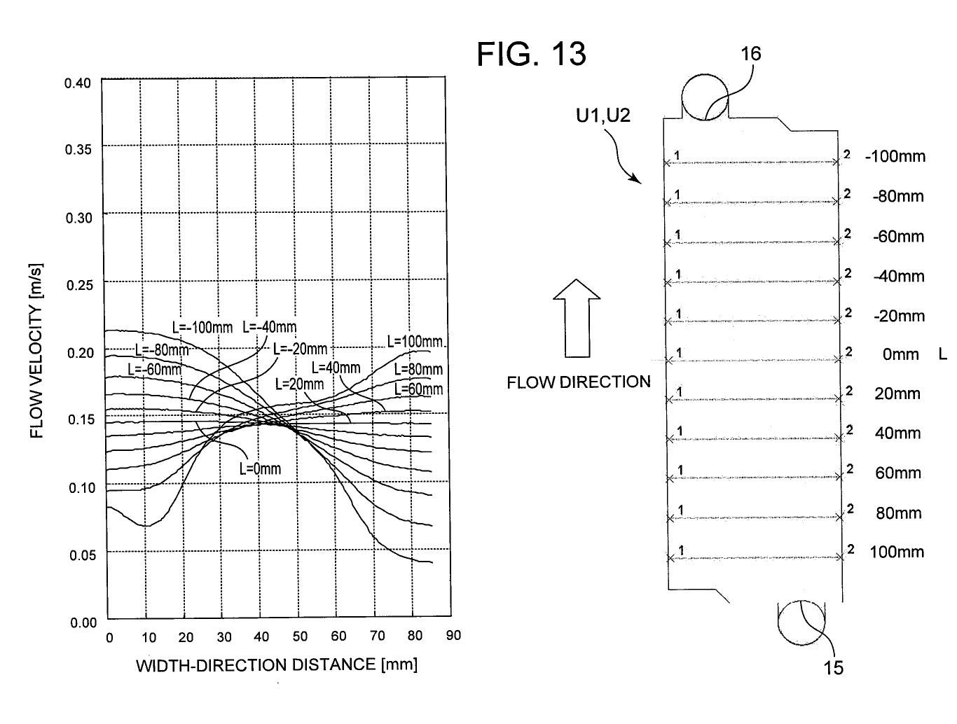

FIGS. 12 and 13 show the rate distribution of the fluid flowing through the unit U1 or U2 in a case where each unit U1 or U2 has a constitution including the fin parallel region V between the fin orthogonal regions H. In this case, a ratio of the fin orthogonal region H on the inflow port 15 side with respect to all the fins 5 is set to 3.5%, a ratio of the fin orthogonal region H on the outflow port 16 side is set to 3.5%, and a ratio of the fin parallel region V provided between the fin orthogonal region H on the inflow port 15 side and the fin orthogonal region H on the outflow port 16 side is set to 93% (hereinafter, the units U1, U2 having this ratio will be referred to as the first units). Moreover, the flow velocity of the fluid flowing through the heat exchanger constituted of the first units U1, U2 is set to 2 L/min. In FIG. 12, (A) is the result of the rate distribution of the first units U1, U2. (B) is the result (similar to FIG. 7) of the rate distribution of the above V-type unit, and is shown in the drawing for comparison with (A).

It is seen from FIGS. 12 and 13 that in a constitution including the first units U1, U2, the rate deviation of the fluid through each flow path 4 is small, and the fluid entirely flows through the whole flow paths 4 as compared with the V-type unit. Moreover, the pressure difference of the fluid between the inlet side and the outlet side in the heat exchanger is 5729 Pa. Therefore, it has been clarified that the pressure drop can remarkably be suppressed as compared with the heat exchanger constitute of the H-type unit.

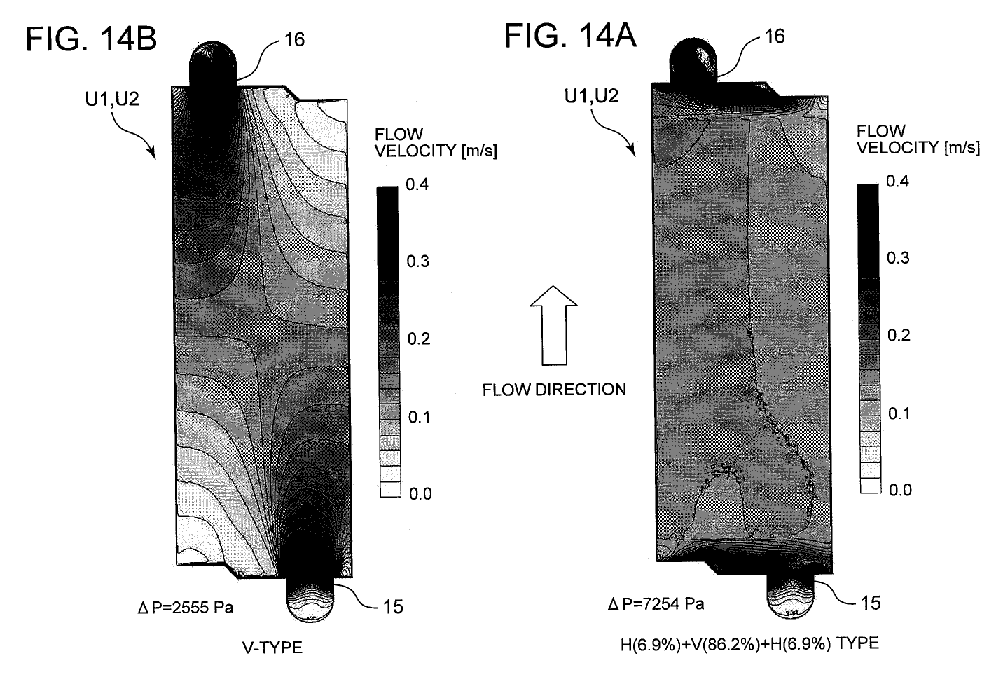

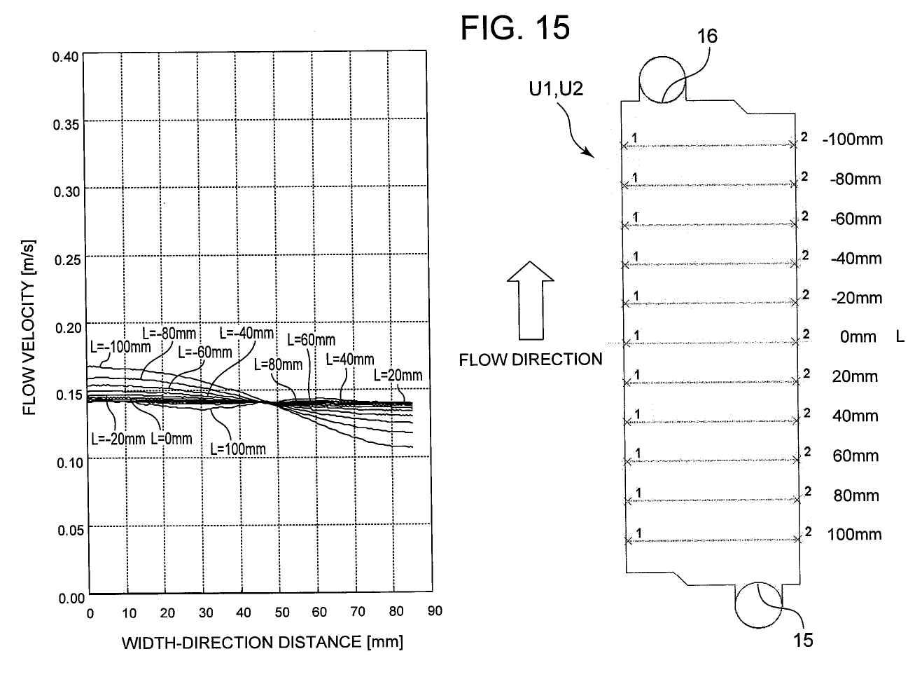

Next, the ratio between the fin orthogonal region H and the fin parallel region V in the first units U1, U2 is changed to constitute the respective units U1, U2, and the fluid is allowed to flow through the heat exchanger constituted of the respective units U1, U2 to check a flow field. First, the ratio of the fin orthogonal region H on the inflow port 15 side with respect to all the fins 5 is set to 6.9%, the ratio of the fin orthogonal region H on the outflow port 16 side is set to 6.9%, and the ratio of the fin parallel region V provided between the fin orthogonal region H on the inflow port 15 side and the fin orthogonal region H on the outflow port 16 side is set to 86.2% (hereinafter, the units U1, U2 having this ratio will be referred to as the second units). In this case, the rate distribution of the fluid flowing through the second units U1, U2 is shown in FIGS. 14(A) and 15. It is to be noted that in FIG. 14, (B) is the result (similar to FIGS. 7 and 12(B)) of the rate distribution of the above V-type unit, and is shown in the drawing for comparison with (A). Moreover, the flow velocity of the fluid flowing through the heat exchanger constituted of the second units U1, U2 is set to 2 L/min in the same manner as described above.

It is seen from FIGS. 14 and 15 that in the constitution of the second unit, the fluid flows through the whole flow paths 4, and the fluid entirely flows through the flow path 4 as compared with the V-type unit. Moreover, it has been seen that the ratio of the fin orthogonal region H with respect to all the fins 5 is higher than that of the first units U1, U2, and hence the drift of the fluid through each flow path 4 decreases as compared with the first units U1, U2. Moreover, the pressure difference of the fluid between the inlet side and the outlet side in the heat exchanger is 7254 Pa. In this case, the ratio of the fin orthogonal region H with respect to all the fins 5 is larger than that of the first units U1, U2, the pressure drop becomes larger than that in a case where the first units U1, U2 are used, but the pressure drop can noticeably be suppressed as compared with the heat exchanger constituted of the H-type unit.

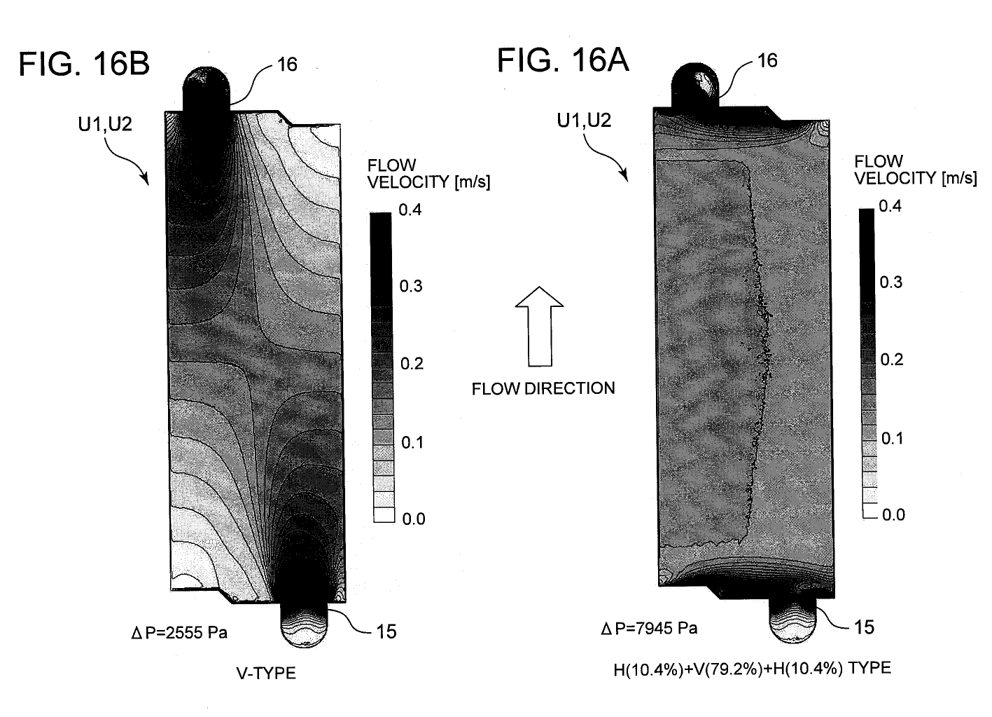

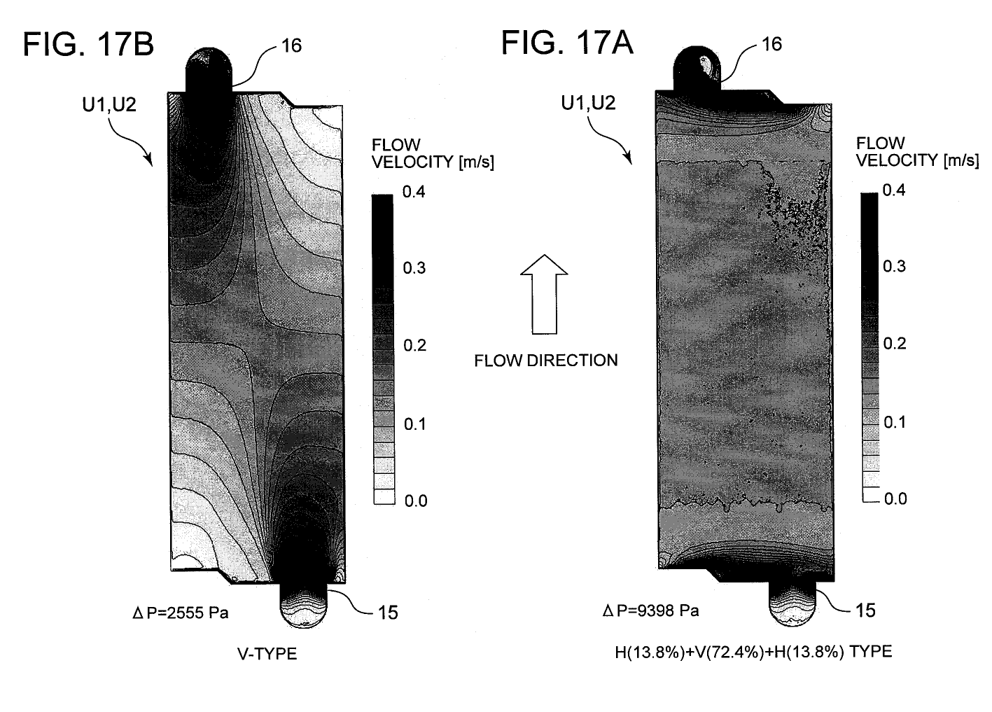

Moreover, FIG. 16(A) is a diagram showing the rate distribution of the fluid in a case where the units U1 and U2 are used in which the ratio of the fin orthogonal region H on the inflow port 15 side with respect to all the fins 5 is 10.4%, the ratio of the fin orthogonal region H on the outflow port 16 side is 10.4%, and the ratio of the fin parallel region V provided between the fin orthogonal region H on the inflow port 15 side and the fin orthogonal region H on the outflow port 16 side is 79.2% (hereinafter, the units U1, U2 having this ratio will be referred to as the third units). FIG. 17(A) is a diagram showing the rate distribution of the fluid in a case where the units U1 and U2 are used in which the ratio of the fin orthogonal region H on the inflow port 15 side with respect to all the fins 5 is 13.8%, the ratio of the fin orthogonal region H on the outflow port 16 side is 13.8%, and the ratio of the fin parallel region V provided between the fin orthogonal region H on the inflow port 15 side and the fin orthogonal region H on the outflow port 16 side is 72.4% (hereinafter, the units U1, U2 having this ratio will be referred to as the fourth units). It is to be noted that the flow velocity of the fluid flowing through the heat exchanger constituted of the third and fourth units U1, U2 is set to 2 L/min in the same manner as described above. Moreover, in both FIGS. 16, 17, (B) is a result of the rate distribution of the V-type unit in the same manner as described above.

As shown in FIG. 16 or 17, even in the constitution of the third or fourth unit, as compared with the V-type unit, the fluid can be allowed to flow through the flow path 4. Moreover, when the third unit is used, the pressure difference of the fluid between the inlet side and the outlet side in the heat exchanger is 7954 Pa. When the fourth unit is used, the pressure difference is 9398 Pa. It has been found that the pressure drop can be suppressed as compared with the heat exchanger constituted of the H-type unit in the same manner as described above. However, it has been found that the pressure drop remarkably increases as compared with a case where the heat exchanger constituted of the first units U1, U2 is used.

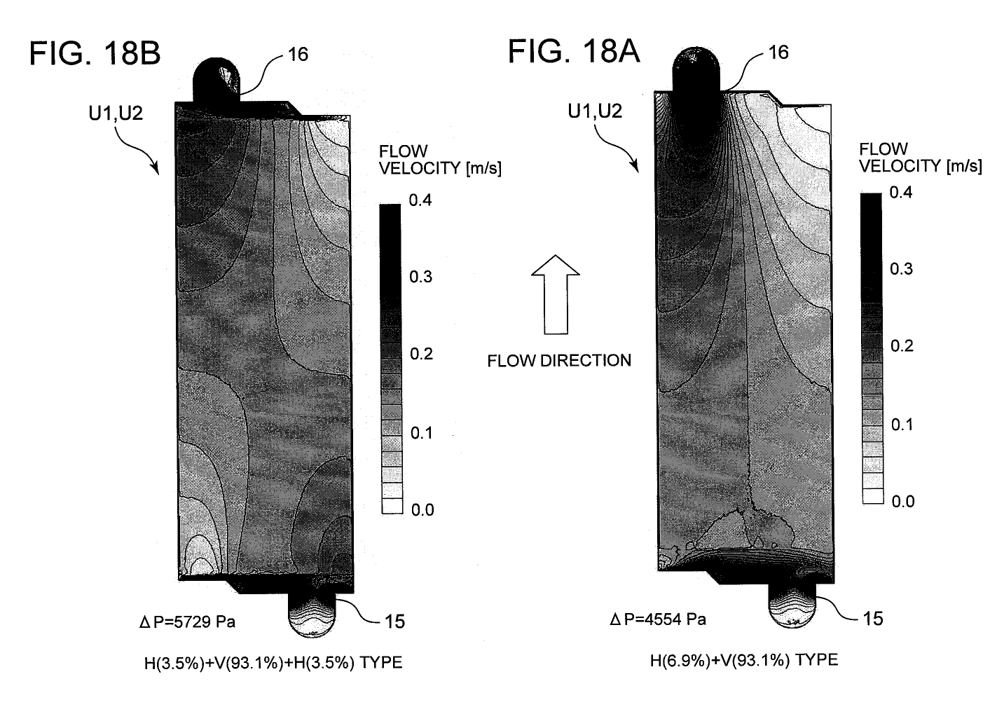

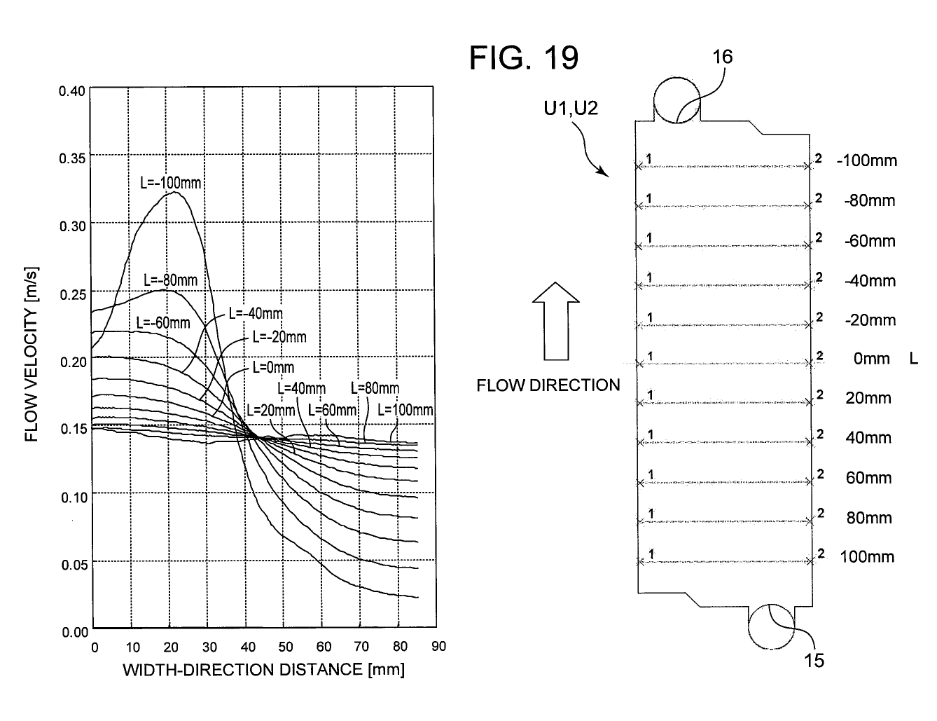

Next, there will be investigated a case where the fin orthogonal region H is arranged on the inflow port 15 side and the fin parallel region V is arranged on the outflow port 16 side. First, the heat exchanger is constituted of the unit (hereinafter referred to as the fifth unit) in which the ratio of the fin orthogonal region H arranged on the inflow port 15 side with respect to all the fins 5 is 6.9%, and the ratio of the fin parallel region V arranged on the outflow port 16 side is 93.1%, to check the flow field. In this case, the rate distribution of the fluid flowing through the fifth units U1, U2 is shown in FIG. 18(A) and FIG. 19. It is to be noted that in FIG. 18, (B) is a result (similar to FIG. 12(A)) of the rate distribution of the first units U1, U2 constituted of the fin orthogonal region H and the fin parallel region having a ratio substantially equal to that of the fifth unit, and is shown in the drawing for comparison with FIG. 18(A). In this case, the flow velocity of the fluid flowing through the heat exchanger constituted of the fifth units U1, U2 is set to 2 L/min in the same manner as described above.

As seen from FIGS. 18 and 19, in the constitution of the fifth unit, the inflow port 15 side has less fluid drift, and around this side, the fluid is dispersed in a width direction (a transverse direction of FIG. 18) of the flow path 4 to uniformly flow, but on the outflow port 16 side, the flow of the fluid is concentrated around the outflow port 16, and the flow velocity of the fluid lowers away from the port. That is, it has been found that on the outflow port 16 side, the flow velocity of the fluid does not become uniform, thereby generating the drift. It is to be noted that the pressure difference of the fluid between the inlet side and the outlet side in the heat exchanger constituted of the fifth unit is 4554 Pa.

Thus, it has been found that in the fifth unit, the pressure drop can be suppressed, but the flow velocity of the fluid through each flow path 4 does not become uniform, and the drift is generated to increase the rate deviation of the fluid. Moreover, it has been clarified that as compared with a case where the fifth unit is used, when the first unit shown in FIG. 18(B) is used, the flow velocity of the fluid through each flow path 4 becomes uniform, and the non-uniform rate distribution can be improved.

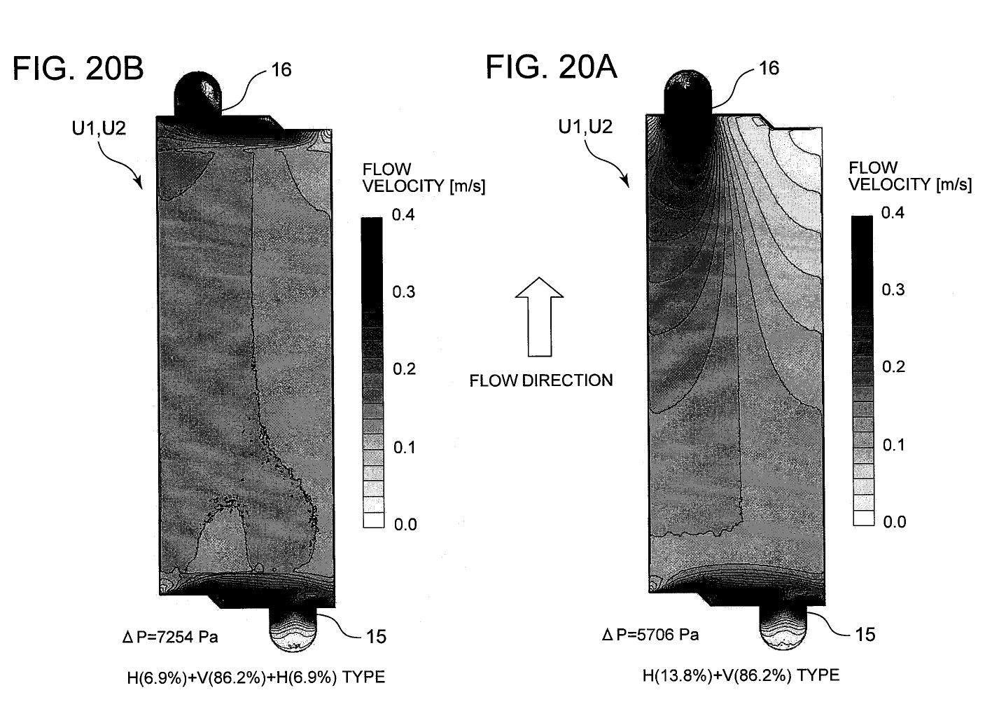

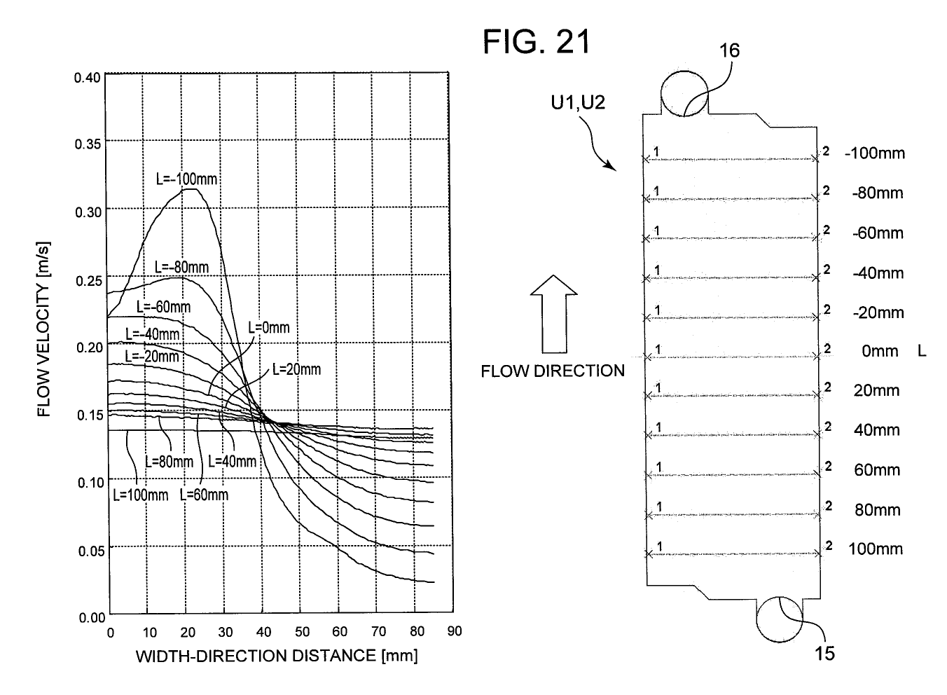

Next, the ratio of the fin orthogonal region H and the fin parallel region V of the fifth units U1, U2 is changed to constitute the respective units U1, U2, and the fluid is allowed to flow through the heat exchanger constituted of the units U1, U2 to check the flow field. In this case, the ratio of the fin orthogonal region H arranged on the inflow port 15 side with respect to all the fins 5 is set to 13.8%, and the ratio of the fin parallel region V arranged on the outflow port 16 side is set to 86.2% (hereinafter referred to as the sixth unit). In this case, the rate distribution of the fluid flowing through the sixth unit is shown in FIG. 20(A) and FIG. 21. It is to be noted that in FIG. 20, (B) is a result (similar to FIG. 14(A)) of the rate distribution of the second units U1, U2 constituted of the fin orthogonal region H and the fin parallel region having a ratio substantially equal to that of the sixth unit, and is shown in the drawing for comparison with FIG. 18(A). In this case, the flow velocity of the fluid flowing through the heat exchanger constituted of the sixth units U1, U2 is set to 2 L/min in the same manner as described above.

As shown in FIGS. 20 and 21, it has been found that as to the constitution of the sixth unit, in the same manner as in the constitution of the fifth unit, the inflow port 15 side has less fluid drift, and the fluid is dispersed in the width direction (a transverse direction of FIG. 21) of the flow path 4 to uniformly flow. Moreover, it has been found that on the outflow port 16 side, the flow of the fluid is concentrated around the outflow port 16, and the flow velocity of the fluid lowers away from the port in the same manner as in the above constitution of the fifth unit. Therefore, it has been found that on the outflow port 16 side, the flow velocity of the fluid does not become uniform, thereby generating the drift. It is to be noted that the pressure difference of the fluid between the inlet side and the outlet side in the heat exchanger constituted of the sixth unit is 5706 Pa.

As described above, it has been found that when the fin orthogonal region H is arranged on the inflow port 15 side and the fin parallel region V is arranged on the outflow port 16 side, as compared with the heat exchanger constituted of the V-type unit, the fluid non-uniform rate distribution can be improved, and as compared with the heat exchanger constituted of the H-type unit, the pressure drop can be suppressed. However, the drift on the outflow port 16 side is hardly improved. It has been clarified that even when the ratio of the fin orthogonal region H is increased or decreased, the drift on the inflow port 15 side cannot be improved.

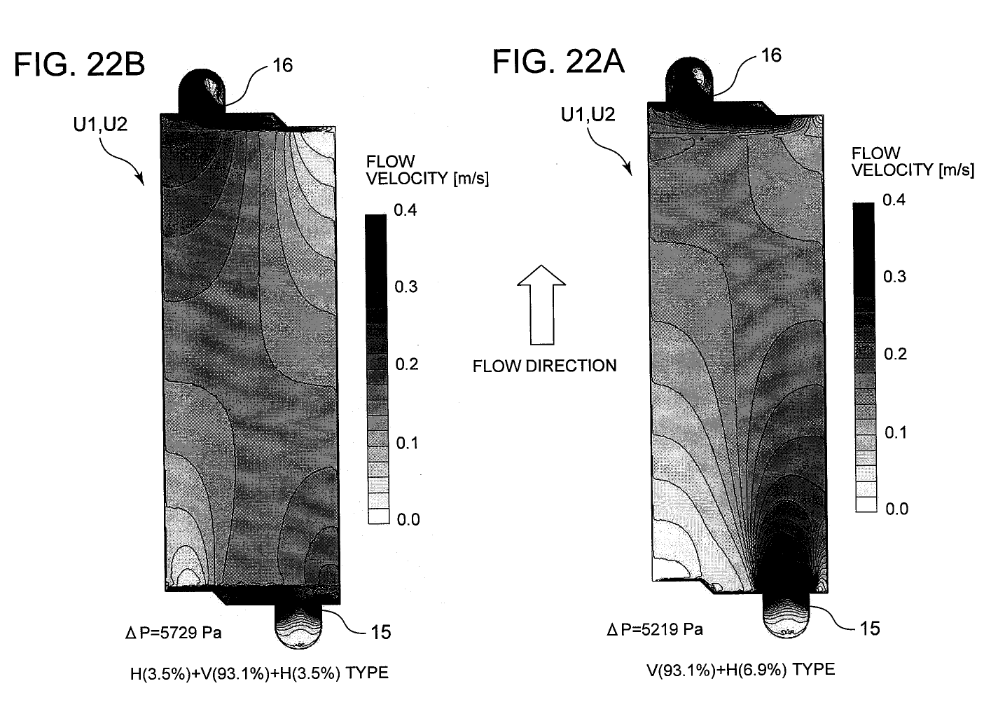

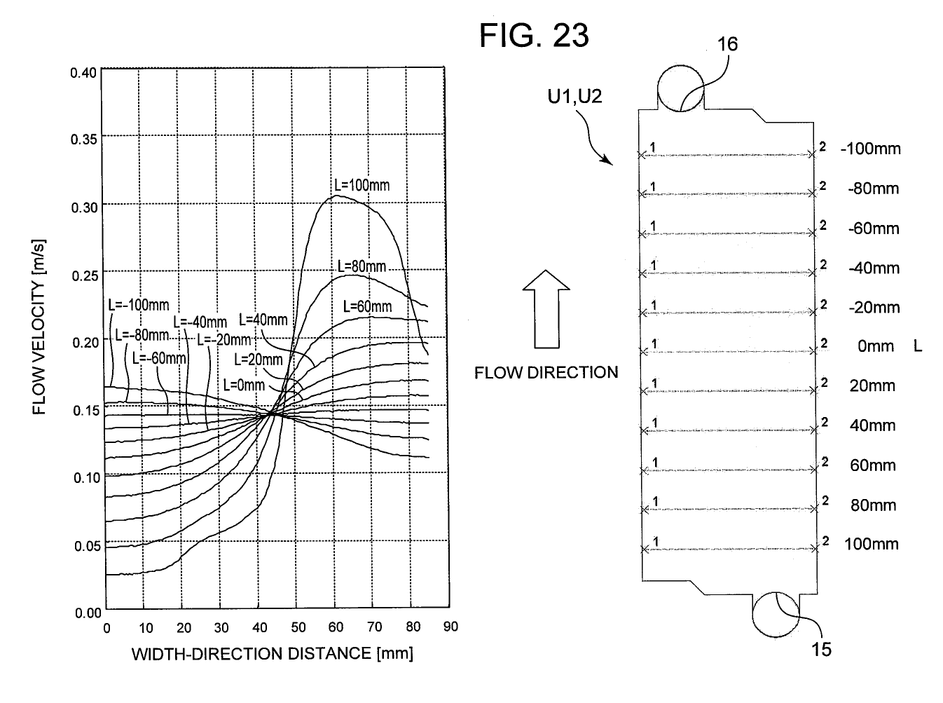

Next, there will be investigated a case where the fin parallel region V is arranged on the inflow port 15 side and the fin orthogonal region H is arranged on the outflow port 16 side. First, the ratio of the fin parallel region V arranged on the inflow port 15 side with respect to all the fins 5 is set to 91.3%, the ratio of the fin orthogonal region H arranged on the outflow port 16 side is set to 6.9%, and the heat exchanger is constituted of a unit having such ratios (hereinafter referred to as the seventh unit) to check the flow field. In this case, the rate distribution of the fluid flowing through the seventh units U1, U2 is shown in FIG. 22(A) and FIG. 23. It is to be noted that in FIG. 22, (B) is a result (similar to FIG. 12(A)) of the rate distribution of the first units U1, U2 constituted of the fin orthogonal region H and the fin parallel region having a ratio substantially equal to that of the seventh unit, and is shown in the drawing for comparison with FIG. 22(A). In this case, the flow velocity of the fluid flowing through the heat exchanger constituted of the seventh units U1, U2 is set to 2 L/min in the same manner as described above.

As shown in FIGS. 22 and 23, in the constitution of the seventh unit, the outflow port 16 side has less fluid drift, and around this side, the fluid is dispersed in a width direction (a transverse direction of FIG. 22) of the flow path 4 to uniformly flow, but on the inflow port 15 side, the flow of the fluid is concentrated around the inflow port 15, and the flow velocity of the fluid lowers away from the port. That is, it has been found that on the inflow port 15 side, the flow velocity of the fluid does not become uniform, thereby generating the drift. It is to be noted that the pressure difference of the fluid between the inlet side and the outlet side in the heat exchanger constituted of the seventh unit is 5219 Pa.

Thus, it has been clarified that in the seventh unit, the pressure drop can be suppressed, but the flow velocity of the fluid through each flow path 4 does not become uniform, and the drift is generated. Therefore, as compared with a case where the first unit shown in FIG. 22(B) is used, the non-uniform rate distribution can be improved.

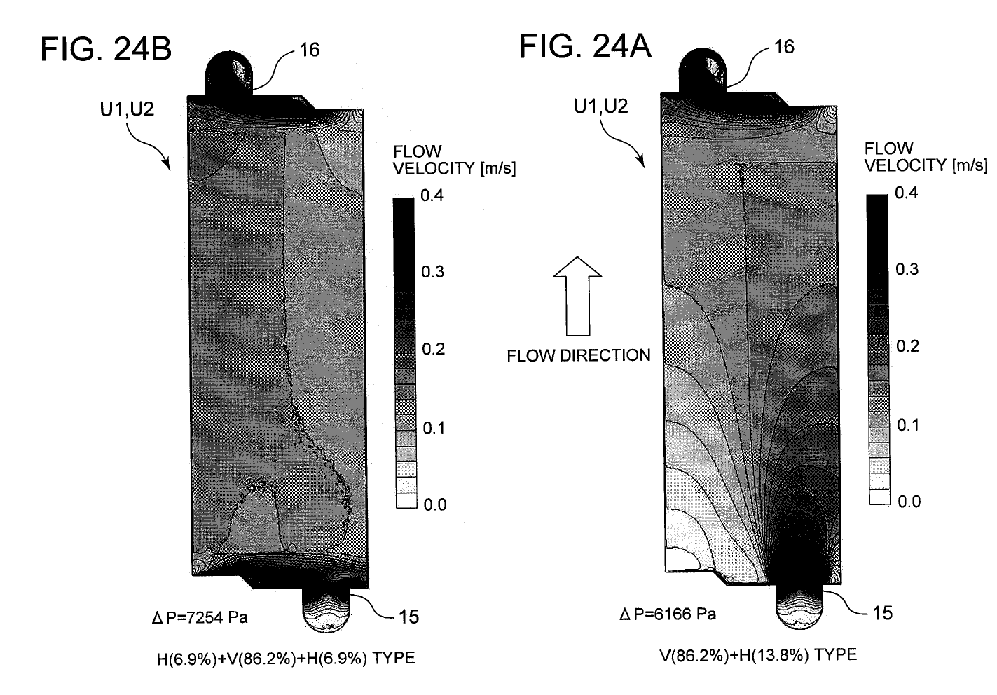

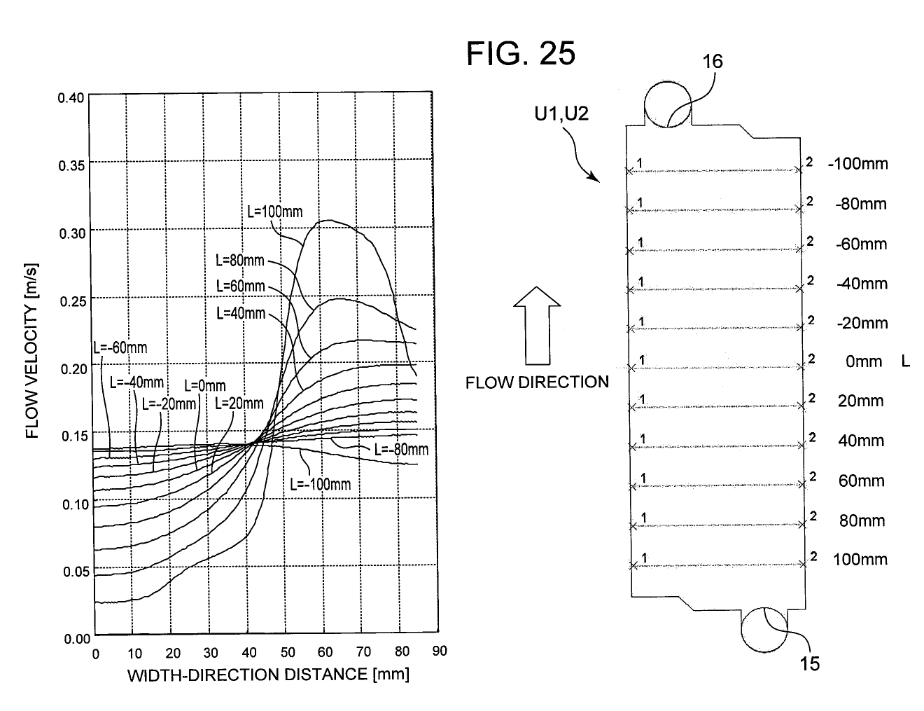

Next, the ratio of the fin orthogonal region H and the fin parallel region V of the seventh units U1, U2 is changed to constitute the respective units U1, U2, and the fluid is allowed to flow through the heat exchanger constituted of the units U1, U2, to check the flow field. In this case, the ratio of the fin parallel region V arranged on the inflow port 15 side with respect to all the fins 5 is set to 86.2%, and the ratio of the fin orthogonal region H arranged on the outflow port 16 side is set to 13.8% (hereinafter referred to as the eighth unit). In this case, the rate distribution of the fluid flowing through the eighth unit is shown in FIG. 24(A) and FIG. 25. It is to be noted that in FIG. 24, (B) is a result (similar to FIG. 14(A)) of the rate distribution of the second units U1, U2 constituted of the fin orthogonal region H and the fin parallel region having a ratio substantially equal to that of the eighth unit, and is shown in the drawing for comparison with FIG. 24(A). In this case, the flow velocity of the fluid flowing through the heat exchanger constituted of the eighth units U1, U2 is set to 2 L/min in the same manner as described above.

As shown in FIGS. 24 and 25, it has been found that as to the constitution of the eighth unit, in the same manner as in the constitution of the seventh unit, the outflow port 16 side has less fluid drift, and the fluid is dispersed in the width direction (a transverse direction of FIG. 24) of the flow path 4 to uniformly flow. Moreover, it has been found that on the inflow port 15 side, the flow of the fluid is concentrated around the inflow port 15, and the flow velocity of the fluid lowers away from the port in the same manner as in the above constitution of the seventh unit. Therefore, it has been found that on the inflow port 15 side, the flow velocity of the fluid does not become uniform, thereby generating the drift. Moreover, the drift around the inflow port 15 is hardly different from that in the seventh unit. It is to be noted that the pressure difference of the fluid between the inlet side and the outlet side in the heat exchanger constituted of the eighth unit is 6166 Pa.

When the above seventh and eighth units are used, it has been eventually found that when the fin parallel region V is arranged on the inflow port 15 side and the fin orthogonal region H is arranged on the outflow port 16 side, as compared with the heat exchanger constituted of the V-type unit, the non-uniform rate distribution of the fluid can be improved, and as compared with the heat exchanger constituted of the H-type unit, the pressure drop can be suppressed. However, it has been clarified that the drift on the outflow port 16 side is hardly improved and that even when the ratio of the fin orthogonal region H is increased or decreased, the drift on the outflow port 16 side can hardly be improved.

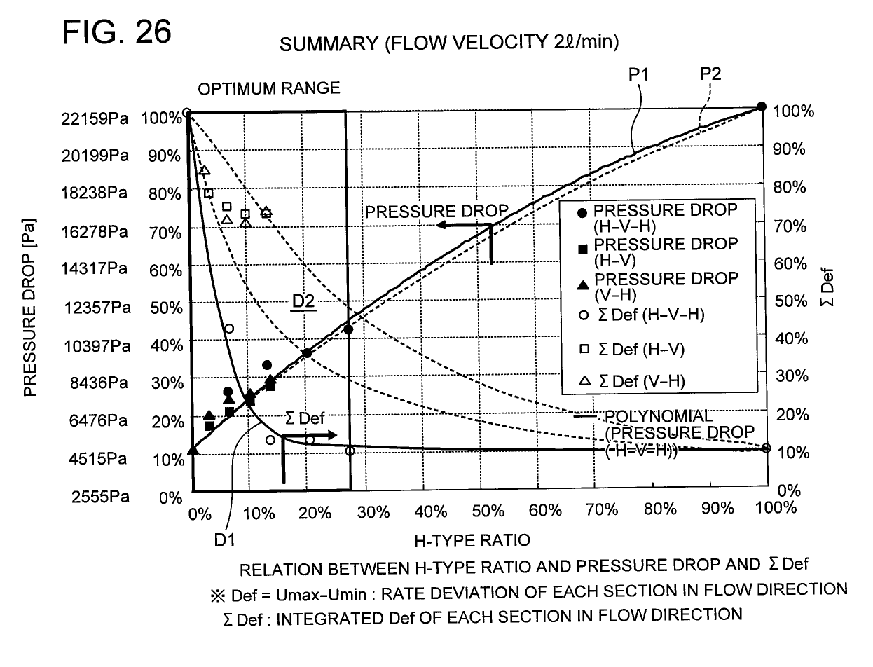

Here, FIG. 26 is the summary of the results described above in detail, a main axis of the ordinate indicates the pressure drop, a second axis indicates the rate deviation of each section in the flow direction, and the abscissa indicates the ratio of the fin orthogonal region H with respect to all the fins 5. That is, 0% of the abscissa indicates the heat exchanger (i.e., a case where the heat exchanger is constituted of the V-type unit) constituted of the unit in which all the fins 5 are constituted of the fin parallel region V, and 100% indicates the heat exchanger (i.e., a case where the heat exchanger is constituted of the H-type unit) constituted of the unit in which all the fins 5 are constituted of the fin orthogonal region H).

In FIG. 26, P1 is a pressure drop in a case where the ratio of the fin orthogonal region H is changed in the heat exchanger constituted of the unit in which the fin orthogonal regions H are arranged on the inflow port 15 and outflow port 16 sides, and the fin parallel region V is arranged between the fin orthogonal regions H, and P2 is a pressure drop in a case where the ratio of the fin orthogonal region H is changed in the heat exchanger constituted of the unit in which the fin parallel region V is arranged on the inflow port 15 side and the fin orthogonal region H is arranged on the outflow port 16 side.

Moreover, D1 is a rate difference in a case where the ratio of the fin orthogonal region H is changed in the heat exchanger constituted of the unit in which the fin orthogonal regions H are arranged on the inflow port 15 and outflow port 16 sides, and the fin parallel region V is arranged between the fin orthogonal regions H, and a region of D2 shown by broken lines is a rate deviation in a case where the ratio of the fin orthogonal region H is changed in the heat exchanger constituted of the unit in which the fin orthogonal region H is arranged on the inflow port 15 side and the fin parallel region V is arranged on the outflow port 16 side.

It has been found from FIG. 26 that the pressure drop of each heat exchanger increases with the increase of the fin orthogonal region H, and a change ratio is substantially proportional. On the other hand, it has been found that the flow velocity deviation of the fluid in each heat exchanger (an integrated value obtained by integrating a difference between the maximum flow velocity and the minimum flow velocity of the fluid in a plane crossing the flow direction of the fluid at right angles with respect to the flow direction of the fluid) lowers with the increase of the fin orthogonal region H, but the value has an inflection point at which a tilt becomes moderate. Specifically, this respect will be described using the result (D1) of the heat exchanger constituted of the unit in which the fin orthogonal regions H are arranged on the inflow and outflow port sides and the fin parallel region V is arranged between the fin orthogonal regions H. When the ratio of the fin orthogonal region H is increased from a value of 100% where the ratio of the fin orthogonal region H is zero, the flow velocity deviation rapidly decreases, and the tilt becomes moderate around the ratio (about 15%) of the fin orthogonal region H in excess of 10%. When the ratio exceeds 30%, the flow velocity deviation becomes substantially constant at about 10%.

That is, it is clear that even when the ratio of the fin orthogonal region H is set to a value higher than 30%, the change of the rate deviation of the fluid is hardly seen. Moreover, even in the case of the using of the heat exchanger constituted of the unit in which the fin orthogonal region H is arranged on the inflow port 15 side and the fin parallel region V is arranged on the outflow port 16 side, when the ratio of the fin orthogonal region H is similarly increased, the value has the inflection point at which the tilt becomes moderate (around a ratio of 28% of the fin orthogonal region H as shown in FIG. 26). Therefore, when the ratio of the fin orthogonal region H of the heat exchanger T is larger than zero and is set to 28% or less as the inflection point, an optimum range can be obtained so as to improve the non-uniform rate distribution while suppressing the pressure drop. When the ratio of the fin orthogonal region H with respect to all the fins 5 is set so as to obtain such an optimum range and the heat exchanger T is manufactured, a heat exchanger having a high performance can be manufactured.

In general, when the heat exchanger T has a constitution including the fin orthogonal region H and the fin parallel region V, the pressure drop can be suppressed while improving the non-uniform rate distribution. In particular, when the fin orthogonal regions H are provided on the inflow port 15 and outflow port 16 sides and the fin parallel region V is provided between the respective fin orthogonal regions H, the drift of the fluid can most effectively be improved, and the whole flow paths 4 can effectively be utilized. In consequence, the heat exchange performance of the heat exchanger T can be improved.

Moreover, to manufacture the heat exchanger T, as to the ratio between the fin orthogonal region H and the fin parallel region V, when the difference between the maximum flow velocity and the minimum flow velocity of the fluid in the plane crossing the flow direction of the fluid at right angles is integrated with respect to the flow direction of the fluid and the ratio of the fin orthogonal region H with respect to the whole is increased, the inflection point where the tilt of the integrated value becomes moderate is regarded as the maximum value, and the ratio of each fin orthogonal region H is set within a range of a value larger than zero to a value of the maximum value or less. At this time, the flat plates 1, 2 and the fins 5 are formed separately, and the fins 5 are received in the flat plates 1, 2 so that the ratio between the fin orthogonal region H and the fin parallel region V is the set ratio.

Thus, as to the ratio between the fin orthogonal region H and the fin parallel region V, when the difference between the maximum flow velocity and the minimum flow velocity of the fluid in the plane crossing the flow direction of the fluid at right angles is integrated with respect to the flow direction of the fluid and the ratio of the fin orthogonal region H with respect to the whole is increased, the inflection point where the tilt of the integrated value becomes moderate is regarded as the maximum value, and the ratio of each fin orthogonal region H is set within a range of a value larger than zero to a value of the maximum value or less. In consequence, it is possible to manufacture the heat exchanger capable of improving the non-uniform rate distribution and having a high performance with less pressure drop.

Particularly in the heat exchanger of the present invention, the flat plates 1, 2 and the fins 5 are separately formed, and the fins 5 are received between the guide plates 10 and 11 in the flat plates 1, 2, and hence the type or shape of the fins 5 . . . received between the guide plates 10 and 11 can arbitrarily be selected for each application, use purpose or the like.

In a conventional heat exchanger, the guide members are formed integrally with the fins. In this case, the shapes of the guide members and the fins are predetermined by a mold, and hence cannot be changed to optimum shapes in accordance with the use purpose. Moreover, each guide member is formed of a thin partition plate, and in a case where the flat plates including the guide members integrally formed with the fins are laminated to constitute the unit, the strength of each guide member lowers owing to such a shape, and it is difficult to obtain a high pressure resistance.

However, according to the structure of the present invention described above in detail, the high pressure resistance can be realized, and the ratio and shape of the fin orthogonal region and the fin parallel region can arbitrarily be set in accordance with the application, use conditions or the like. In consequence, the improvement of the versatility of the heat exchanger can be expected.

What is claimed is:

1. A heat exchanger having a flow path of a first fluid and a flow path of a second fluid and performing heat exchange between both the fluids, the flow paths including flat plates each having an inflow port of the fluid on one end thereof and an outflow port of the fluid on the other end thereof and fins provided in the flat plates,
the heat exchanger comprising:
a fin orthogonal region where the fins cross the flow direction of the fluid from the inflow port to the outflow port; and
a fin parallel region where the fins are disposed in parallel with the flow direction of the fluid from the inflow port to the outflow port.

2. The heat exchanger according to claim 1, wherein the fin orthogonal regions are provided on the sides of the inflow port and the outflow port, and the fin parallel region is provided between the respective fin orthogonal regions.

3. The heat exchanger according to claim 1 or 2, wherein the fins are offset type fins having a rectangular wavy shape.

4. The heat exchanger according to any one of claims 1 to 3, wherein the first fluid or the second fluid is carbon dioxide.

5. A manufacturing method of the heat exchanger according to any one of claims 1 to 4, comprising the steps of:
integrating, with respect to the flow direction of the fluid, a difference between the maximum flow velocity and the minimum flow velocity of the fluid in a plane crossing the flow direction of the fluid at right angles;
increasing a ratio of the fin orthogonal region with respect to the whole;
obtaining, as the maximum value, an inflection point where the tilt of the integrated value becomes moderate; and
setting the ratio of the fin orthogonal region within a range of a value larger than zero to a value of the maximum or less.

6. The manufacturing method of the heat exchanger according to any one of claims 1 to 5, further comprising the steps of: separately forming the flat plates and the fins; and receiving the formed fins in the flat plates.
